(19) United States
(12) Patent Application Publication
(10) Pub. No.: US 2006/0232556 A1
(43) Pub. Date: Oct. 19, 2006

(54) LENS MODULE FOR OPTICAL MOUSE AND RELATED OPTICAL MODULE AND COMPUTER INPUT APPARATUS

(76) Inventor: Mao-Hsiung Chien, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,128

(22) Filed: Nov. 10, 2005

(30) Foreign Application Priority Data
Apr. 13, 2005 (TW) 094205751

(51) Int. Cl. G09G 5/08

(52) U.S. Cl. 345/166

(57) ABSTRACT

A lens module for an optical mouse includes a fixing part and a light guiding part. The fixing part is for fixing a light source, so that light emitted by the light source travels along a predetermined path only, the fixing part comprising at least two fixing members, one of which comprises an engaging portion for engaging the light source at a desired position. The light guiding part guides the light emitted by the light source.

### BACKGROUND OF THE INVENTION

1. Field of the Invention

The present invention relates to an optical mouse, and more particularly, to a lens module for the optical mouse and related optical module and computer input apparatus.

2. Description of the Prior Art

From traditional functions, such as word processing and programming, to modern multimedia, game playing, etc., the personal computer (PC) has developed to play an important role in our daily lives. Mouses used for controlling the PC have improved too. The sensing techniques that a modern mouse applies to determine its movement have advanced from a traditional roller, LED (light emitting diode) optics to laser optics, and the modern mouse has a plurality of functions spanning from traditional cursor controlling to a variety of additional functions, such as zoom in/out and fingerprint identification. With only one finger, the user of the PC can handle everything.

Please refer to FIG. 1, which is a bottom view of an optical mouse 10 according to the prior art. The optical mouse 10 comprises a bottom surface 12 and an opening 14 installed on the bottom surface 12. The optical mouse 10 uses an LED (light emitting diode) 18 (shown in FIG. 2) to project light through the opening 14 onto a working plane 40 (shown in FIG. 3) where the optical mouse 10 is working, and compares a difference between two consecutive images displayed on the working plane 40 by scanning and capturing the images. Every time when the contents of the captured images are changed, the optical mouse 10 uses an inner circuit to calculate the moving information (including moving direction and moving distance), and the moving information, after being transformed into an axis displacement signal, is transmitted via a cable 16 (or wirelessly) to a computer.

In the optical mouse 10 shown in FIG. 1, dust or even static electricity on the working plane 40 can enter the optical mouse 10 through the opening 14, and causes damage to inner circuits of the optical mouse 10.

Please refer to FIG. 2, which is an inner assembly diagram of the optical mouse 10. The optical mouse 10 further comprises a light guiding part 20 installed above the opening 14, a circuit board 22 installed above the light guiding part 20, a light sensing component 24 installed on the circuit board 22, and a clipper 26 installed on the circuit board 22. The LED 18 is installed on the circuit board 22 and serves as a light source of the light sensing component 24. The light sensing component 24 is installed to capture images displayed on the working plane 40 where the optical mouse 10 is moving along, and analyzes and determines the moving information of the optical mouse 10. The clipper 26 is installed to shield the light sensing component 24 from receiving light emitted directly from the LED 18.

The light guiding part 20 comprises an aperture 28, a convex lens 30 installed in the aperture 28, a first total reflection surface 32, and a second total reflection surface 34. The circuit board 22 comprises a hole 36 installed above the convex lens 30, and the aperture 28 as well. The light sensing component 24 is installed above the hole 36 of the circuit board 22. The first total reflection surface 32 protrudes beyond the hole 36, so that the first total reflection surface 32 is located exactly between the LED 18 and the light sensing component 24.

Please refer to FIG. 3, which is a side view of the optical mouse 10. As shown in FIG. 3, the LED 18 emits light 37, and the LED 18 faces the total reflection surface 32. Moreover, since the clipper 26 is designed to have a shape capable of shielding the light sensing component 24 from receiving the light 37 emitted directly from the LED 18, the majority of the light 37 travels to the total reflection surface 32, and is reflected by the first total reflection surface 32 downward to the second total reflection surface 34. After a total reflection process performed by the second total reflection surface 34, the light 37 travels through the opening 14 of the bottom surface 12, and lights up the working plane 40 where the optical mouse 10 is moving along. The working plane 40 modulates the light 37 and reflects the modulated light, called reflecting light 38, to the convex lens 30. The convex lens 30 collects and focuses the reflecting light 38 onto the light sensing component 24. The light sensing component 24 determines the moving direction and the moving distance of the optical mouse 10 according to the variation of the reflecting light 38.

However, since the LED 18 is installed on the circuit board 22, and a relative position between the LED 18 and the light guiding part 20 changes according to a variety of factors such as the position, the height and the tilt angle of the LED 18 on the circuit board 22, a light position where the light 37 projects onto the working plane 40 and the reflecting light 38 change too. Accordingly, the light sensing component 24, when referring to the variation of the reflecting light 38, makes an erroneous judgment on the moving direction and the moving distance of the optical mouse 10.

In order to overcome the above drawback, assembly workers have to ensure that each of the LEDs 18 installed on its corresponding circuit board 22 has an identical position, height and tilt angle. However, this careful scrutiny makes the optical mouse 10 expensive. Even if the LEDs 18 installed on their corresponding circuit boards 22 have identical positions, heights and tilt angles, the LED 18 shakes inevitably when the optical mouse 10 is moving, and the light sensing component 24 makes an erroneous judgment on the moving direction and the moving distance of the optical mouse 10 according to the variation of the reflecting light 38.

Moreover, having the advantage of focusing light, the laser mouse is becoming more and more popular. That is, the advantage of focusing light makes the laser mouse have a constant relative position between the LD (laser diode) and the lens module. If the LED 18 of the optical mouse 10 is replaced with an LD, the above-mentioned error is worsened.

Lastly, if the LED 18 of the optical mouse 10 is replaced by the LD, since laser light emitted by the LD is very concentrated, the convex lens 30, which is used in the light guiding part 20 to collect and focus the reflecting light 38, seems redundant.

### SUMMARY OF THE INVENTION

It is therefore a primary objective of the claimed invention to provide a lens module for an optical mouse and related optical module and computer input apparatus to overcome the above-mentioned problems.

The claimed invention provides a lens module for an optical mouse comprising a fixing part for fixing a light source, so that light emitted by the light source travels along a predetermined path only, and a light guiding part for guiding the light emitted by the light source.

The claimed invention also provides a lens module for an optical mouse comprising a light source for emitting light, a fixing part for fixing the light source, so that the light emitted by the light source travels along a predetermined path only, and a light guiding part for guiding the light emitted by the light source.

The claimed invention also provides a computer input apparatus comprising a housing, the bottom surface of which has an opening toward a working plane, a light source for emitting light, a lens module, and a light sensing unit installed inside the housing and adapted to sense the light, reflected through the opening by the working plane, for generating an image signal. The lens module comprises a fixing part for fixing the light source, so that the light emitted by the light source travels along a predetermined path only, and a light guiding part for guiding the light emitted by the light source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a bottom view of an optical mouse according to the prior art.

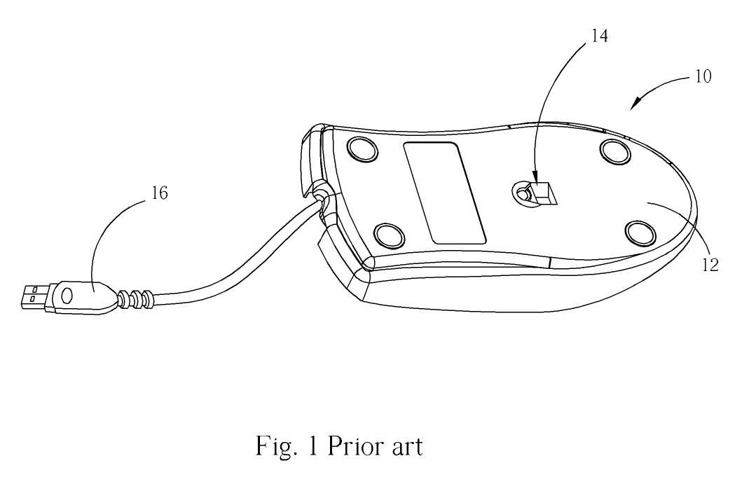

FIG. 2 is an inner assembly diagram of the optical mouse shown in FIG. 1.

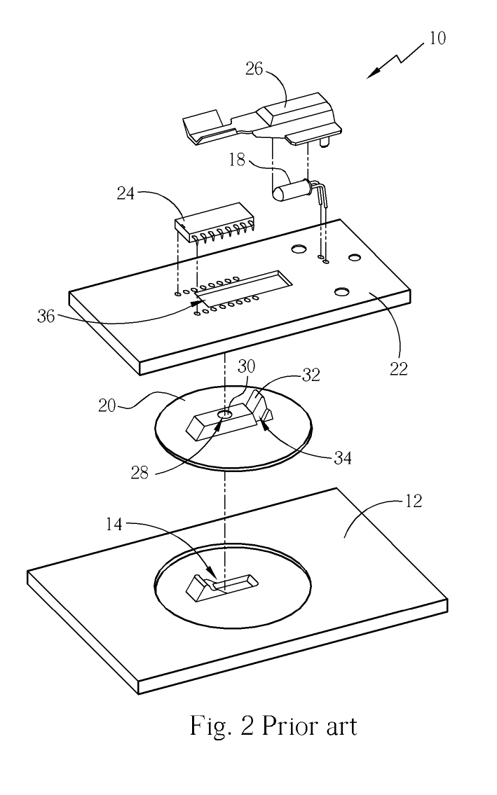

FIG. 3 is a side view of the optical mouse shown in FIG. 1.

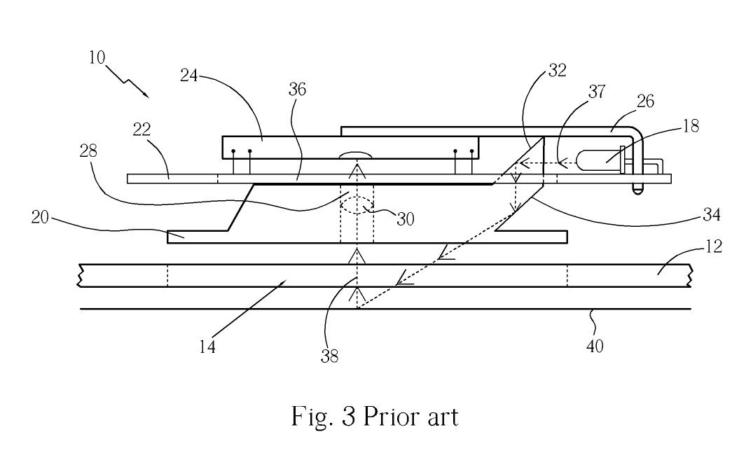

FIG. 4 is a schematic diagram of a lens module for an optical mouse of the preferred embodiment according to the present invention.

FIG. 5 is a bottom view of the lens module shown in FIG. 4.

FIG. 6 is a side view of the optical mouse with the lens module according to the present invention.

### DETAILED DESCRIPTION

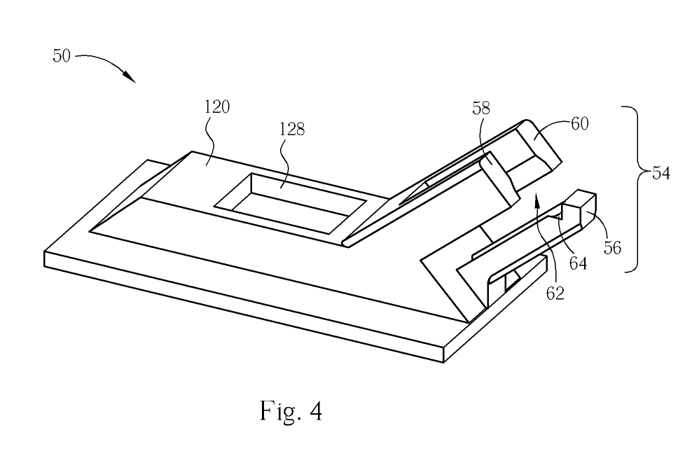

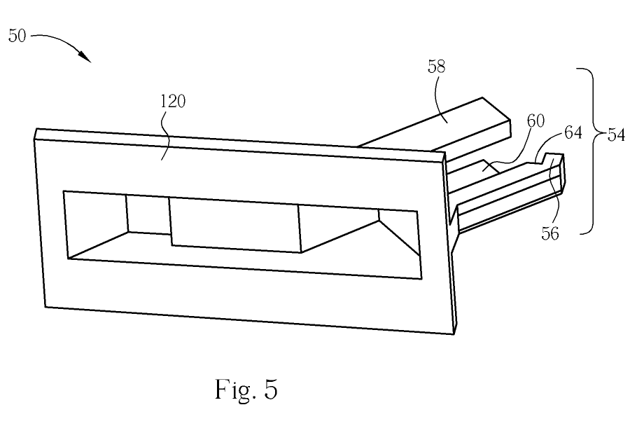

Please refer to FIG. 4 and FIG. 5. FIG. 4 is a schematic diagram of a lens module 50 for an optical mouse of the preferred embodiment according to the present invention. FIG. 5 is a bottom view of the lens module 50. The lens module 50 comprises a light guiding part 120, and a fixing part 54 coupled to the light guiding part 120 for fixing a light source, so that a relative position between the light source and the light guiding part 120 is always constant, and light emitted by the light source travels along a predetermined path. In practice, the optical mouse is a kind of computer input apparatus, and the lens module 50 combines with the light source to form a light module.

In the preferred embodiment of the present invention, the light source is an LED (light emitting diode), an LD (laser diode), or any other light source having a plastic housing formed by injection molding techniques. In general, the plastic housing of the light source comprises a cap and a flange.

The fixing part 54 comprises a first fixing member 56, a second fixing member 58, and a third fixing member 60. The light source is accommodated among the first fixing member 56, the second fixing member 58 and the third fixing member 60. The first fixing member 56, the second fixing member 58, and the third fixing member 60 form a holding space 62 for holding the cap of the LED (the LED is assumed to be the light source). The first fixing member 56 further comprises an engaging portion 64 for engaging the flange of the LED at a desired position.

Therefore, the relative position between the LED, which is fixed by the fixing part 54, and the light guiding part 120 is always constant. Even though the optical mouse is moving, the light sensing component of the optical mouse can still determine a moving direction and a moving distance of the optical mouse correctly according to the variation of the reflecting light.

In the preferred embodiment of the present invention, the fixing part 54 of the lens module 50 comprises three fixing members, the fixing members forming the holding space 62, and one of the fixing members, that is the first fixing member 56, further comprising the engaging portion 64. However, the fixing part 54 of the lens module 50 of the present invention can further comprise two engaging portions installed on the second fixing member 58 and the third fixing member 60 respectively.

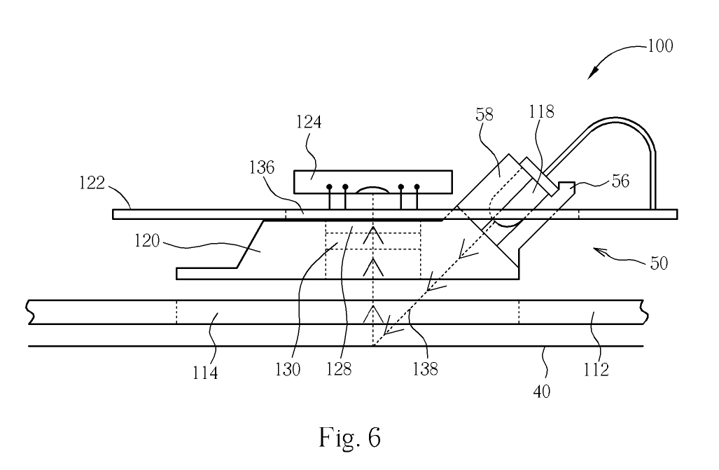

Note that since the light source can be an LD (laser diode), in a laser optical mouse having the LD, an aperture 128 of the light guiding part 120 of the lens module 50 does not need the convex lens (like the convex lens 30 in the prior art light guiding part 20). However, in order to prevent micro particles in the laser optical mouse from contaminating the light sensing component, the lens module 50 still can comprise an aperture transparent plate 130 (shown in FIG. 6) to cover the aperture 128. The aperture transparent plate 130 can be engaged with the aperture 128. The aperture transparent plate 130 is a planar transparent plate, or a convex transparent plate.

Please refer to FIG. 6, which is a side view of an optical mouse 100. In addition to the lens module 50, the optical mouse 100 further comprises a bottom surface 112, an opening 114, a circuit board 122, a light sensing component 124 and a hole 136. Moreover, the optical mouse 100 can comprise an opening transparent plate to seal the opening 114 and to prevent dust and static electricity on the working plane 40 from entering the optical mouse 100 through the opening 114, so as to protect inner circuits of the optical mouse 100. The track of a reflecting light 138 emitted from an LED 118 is illustrated in FIG. 6 as a dotted line with arrows and it needs to be noticed that the track of the reflecting light 138 in FIG. 6 is one light path of a plurality of light paths that have many directions of reflection due to the roughness of the working plane 40.

In contrast to the prior art, the fixing part 54 of the lens module 50 is capable of fixing the light source. Therefore, the relative position between the light source and the light guiding part 120 is constant, and the light sensing component 124 can determine the moving direction and the moving distance of the optical mouse 100 correctly according to the variation of the reflecting light 138. Moreover, the aperture transparent plate 130 to cover the aperture 128 prevents micro particles from contaminating the light sensing component. Lastly, the opening transparent plate to cover the opening 114 prevents dust and static electricity from entering the optical mouse 100, so that the inner circuits of the optical mouse 100 can function normally.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lens module for an optical mouse, the lens module comprising:
a fixing part for fixing a light source, so that light emitted by the light source travels along a predetermined path only, the fixing part comprising at least two fixing members, one of which comprises an engaging portion for engaging the light source at a desired position; and
a light guiding part for guiding the light emitted by the light source.

2. The lens module of claim 1, wherein the light guiding part guides the light emitted by the light source fixed by the fixing part onto a working plane, the light guiding part of the lens module further comprising an aperture through which the light beams reflected by the working plane travel to a sensor of the optical mouse.

3. The lens module of claim 2 further comprising an aperture transparent plate for covering the aperture.

4. The lens module of claim 3, wherein the aperture transparent plate is a planar transparent plate.

5. The lens module of claim 3, wherein the aperture transparent plate is a convex transparent plate.

6. The lens module of claim 3, wherein the aperture transparent plate is engaged with the aperture.

7. A lens module for an optical mouse, the lens module comprising:
a light source for emitting light;
a fixing part for fixing the light source, so that the light emitted by the light source travels along a predetermined path only, the fixing part comprising at least two fixing members, one of which comprises an engaging portion for engaging the light source at a desired position; and
a light guiding part for guiding the light emitted by the light source.

8. The lens module of claim 7, wherein the light source is an LED (light emitting diode).

9. The lens module of claim 7, wherein the light source is an LD (laser diode).

10. A computer input apparatus comprising:
a housing, the bottom surface of which has an opening toward a working plane;
a light source for emitting light;
a lens module, comprising:
a fixing part for fixing the light source, so that the light emitted by the light source travels along a predetermined path only, the fixing part comprising at least two fixing members, one of which comprises an engaging portion for engaging the light source at a desired position; and
a light guiding part for guiding the light emitted by the light source; and
a light sensing unit installed inside the housing and adapted to sense the light, reflected through the opening by the working plane, for generating an image signal.

11. The computer input apparatus of claim 10 further comprising an opening transparent plate for covering the opening.

12. The computer input apparatus of claim 11, wherein the opening transparent plate seals the opening.
